(19) United States
(12) Patent Application Publication
(10) Pub. No.: US 2020/0372014 A1
(43) Pub. Date: Nov. 26, 2020

(54) FULL-STACK SYSTEM AND METHOD FOR BLOCKCHAIN ANALYTICS

(71) Applicants: Qatar University, Doha (QA); Qatar Foundation for Education, Science and Community Development, Doha (QA)

(72) Inventors: Yazan Boshmaf, Doha (QA); Husam Al Jawaheri, Doha (QA); Mashael Al Sabah, Doha (QA)

(21) Appl. No.: 16/880,575

(22) Filed: May 21, 2020

Related U.S. Application Data
(60) Provisional application No. 62/852,448, filed on May 24, 2019.

(51) Int. Cl. G06F 16/23; G06F 16/245

(52) U.S. Cl. CPC G06F 16/2379; G06F 16/245

(57) ABSTRACT

A system and method for performing full-stack blockchain analytics is disclosed. For example, blockchain analysis system comprises a blockchain operation module which integrates with the blockchain network and contains the data source that contains a plurality of blockchain data. The analysis system further comprises a blockchain analysis module that parses and analyzes the blockchain data. Additionally, the system comprises a blockchain tag module that determines a plurality of customizable tags based on the blockchain data and external data sources, and defines a low-level query interface that integrates customizable tags as objects into the blockchain data. The analysis system also comprises a blockchain search module that receives a blockchain search request, maintains a plurality of search indexes and a plurality of user-specific data, and determines a blockchain search result based on the blockchain search request and a plurality of tagged and untagged blockchain data.

### CROSS-REFERENCE TO RELATED PATENT APPLICATION

The present application claims the benefit of priority to U.S. Provisional Patent Application No. 62/852,448, filed May 24, 2019 and the contents of which are incorporated herein by reference in its entirety.

### BACKGROUND

An ever-expanding amount of data contained within blockchain necessitates that users, enforcement authorities, and any others with an interest in the data found in blockchain, be able to easily search through blockchain data to find useful connections and links. Blockchain data typically contains valuable data describing transactions and digital assets. In some instances, blockchain data may comprise relatively large amounts of data. For example, a popular blockchain may contain over 180 GB of data, though this amount will only continue to grow larger and larger as more transactions occur and more assets are attained. These forms of data are notoriously difficult to analyze and search. Raw blockchain data is optimized for validating transactions and ensuring the data is not corruptive. As such, prior common analysis methods, such as address linking, are highly inefficient and difficult to implement. Therefore, there exists a need for a system and method that allows a user to easily analyze and search blockchain data for desired information.

Prior solutions have attempted to solve the existing difficulties in analyzing and searching blockchain data to little avail. The prior solutions have enabled basic analysis functions of blockchain data, but did so by focusing on analyzing core blockchain data, ignoring auxiliary data captured within the blockchain data. One issue with such an approach is that a user or enforcement authority may be interested in analyzing blockchain data for privacy or security concerns. For example, an enforcement authority may wish to search a collection of blockchain data to determine the identities of users that have completed a transaction with a known criminal organization. Such an analysis depends on linking the core data of the blockchain to users or services through recorded transactions, which relies heavily on the auxiliary data ignored in prior solutions.

Other prior solutions have transformed raw blockchain data into a stripped-down, simple structure that can fit in, or map, to memory. One issue with this approach is that, again, the auxiliary information data, such as transaction scripts, hashes, or any annotations in general, are not part of this data structure. As such, there is a need for a system and method that allows analysis of blockchain data, including the auxiliary data, determines links between users and services that are involved in the use of the blockchain data, and allows a user to easily search for requested information contained within the blockchain data.

### SUMMARY

A system and method for performing full-stack blockchain analytics is disclosed. For example, blockchain analysis system comprises a blockchain data source that contains a plurality of blockchain data. The analysis system further comprises a blockchain analysis module that analyzes the core data of the blockchain data. Additionally, the system comprises a blockchain tag module that determines a plurality of customizable tags based on the blockchain data and defines a low-level query interface that integrates customizable tags as objects based on the customizable tags. The analysis system also comprises a blockchain search module that receives a blockchain search request, maintains a plurality of search indexes and a plurality of user-specific data, and determines a blockchain search result based on the blockchain search request.

In an example, a system includes a blockchain comprising a plurality of blocks. Each block includes a plurality of transactions and a plurality of addresses. Each transaction is associated with at least one address in the plurality of addresses. A server system is in operative communication with the blockchain system. The server system includes a processor and instructions stored in non-transitory machine-readable media. The instructions are configured to cause the server system to implement a vertical crawler to capture data from an external data source, the external data source different from the blockchain. The captured data from the external source is annotated with at least one tag in a plurality of tags. Blockchain data is parsed from at least one block in the plurality of blocks of the blockchain. The at least one tag in the plurality of tags is linked with an address in the plurality of addresses parsed from the at least one block in the plurality of blocks of the blockchain. The address in the plurality of addresses is annotated with the at least one tag.

In an example, a method includes implementing a vertical crawler to capture data from an external data source. The external data source is different from the blockchain. The blockchain comprising a plurality of blocks. Each block includes a plurality of transactions and a plurality of addresses. Each transaction is associated with at least one address in the plurality of addresses. The captured data from the external source is annotated with at least one tag in a plurality of tags. Blockchain data is parsed from at least one block in the plurality of blocks of the blockchain. The at least one tag in the plurality of tags is linked with an address in the plurality of addresses parsed from the at least one block in the plurality of blocks of the blockchain. The address in the plurality of addresses is annotated with the at least one tag.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 is a flow block diagram illustrating a layered blockchain analysis system, according to an example of the present disclosure.

FIG. 2 is a flow block diagram illustrating a layered blockchain analysis system, according to another example of the present disclosure.

FIG. 3 is a block diagram of a layered blockchain analysis system, according to an example of the present disclosure.

FIG. 4 is a flowchart illustrating an example of analyzing and layering a blockchain, according to an example of the present disclosure.

### DETAILED DESCRIPTION

A blockchain is a distributed database or a distributed ledger whose beneficial attributes include permanency and security. Generally, the blockchain can be used to store, monitor, or document public and sensitive information related to an industry. Conventional blockchain systems are used to facilitate and/or track monetary transfers, digital assets, and many other types of data that require strict record keeping is becoming more and more prevalent. As used herein, the term “blockchain” refers to a distributed database, a distributed ledger, or cloud platforms with similar immutability and data characteristics. The blockchain includes a plurality of blocks (e.g., blockchain entries). Each block includes information such as transactions, transaction record components, transaction entities, and the like. The term “transaction,” as used herein includes, but is not limited to financial transactions, agreements, transfers, messages, and other interactions between users over the network.

The present disclosure provides for the analysis of blockchain data through the use of a layered architecture system, where each layer performs one of analyzing, tagging, and searching the blockchain data. For example, one embodiment of the present disclosure comprises a layered blockchain analysis system for analyzing blockchain. This system includes a blockchain data source that contains a collection of blockchain data. The system also includes a blockchain analysis module configured to analyze the core data of the blockchain data. For example, the blockchain analysis module may include an open-source, scalable blockchain analysis system that uses a memory-mapped data structure to represent core transaction data as a graph. In an example, the system may also comprise a blockchain tag module that determines a plurality of customizable tags based on the blockchain data, and defines low-level query interface that integrates the customizable tags as objects. For example, based on the blockchain data, the blockchain tag module may tag a portion of data as a user, service, text, or any of a set of custom tags. In an example, once the blockchain data has been tagged, a blockchain search module, included in an example system, maintains a plurality of search indexes based on the tags created by the blockchain tag module. Then upon receiving a blockchain search request, determines a blockchain search result based on the request and the search indexes and tags.

The layered blockchain analysis system provides technical solutions to computer-centric and internet-centric problems associated with conventional querying or analysis blockchain systems. For example, one challenge associated with analyzing blockchain data are focused on analyzing core blockchain data, and are not designed to systematically incorporate auxiliary data and/or tagging into the analysis. Specifically, the on-disk format of raw blockchain data is highly inefficient for common analysis tasks such as address linking. Accordingly, conventional systems are unable to link users and services through blockchain transaction, thereby rendering it difficult to investigate issues related to privacy and security of the blockchain ecosystem. Doing so would also require more processing power (and therefore time) and substantial memory to store each instance of the raw data that in a format that is optimized for validating transactions and ensuring immutability and not linking. Further, conventional systems are unable to map information auxiliary to core transaction data, such as transaction scripts, hashes, or annotations in general, cannot be part of this data structure and must have their own mappings.

According to various embodiments, the layered blockchain analysis system defines a layered system architecture, where search, tagging, and analysis have separate layers with well-defined and extendable interfaces between them. For example, the tag layer (e.g., tag module) uses vertical crawlers to automatically annotate blockchains through customizable tags and defines a low-level query interface that integrates tags as first-class blockchain objects. A search layer (e.g., search module) allows analysts to search tagged blockchains for useful information in plain English and in real-time, and maintains search indexes and user-specific data (e.g., authentication tokens, queries, preferences) to provide a personalized, full-stack blockchain analysis experience. These problems arise out of the use of computers and the Internet, because each problem involves processing power, bandwidth requirements, storage requirements, and information security, each of which is inherent to the use of computers and the Internet. The problems also arise out of the use of computers and the Internet, because online communications, transactions, and payment services, and the ability to properly analyze and search blockchain information, cannot exist without the use of computers and the Internet.

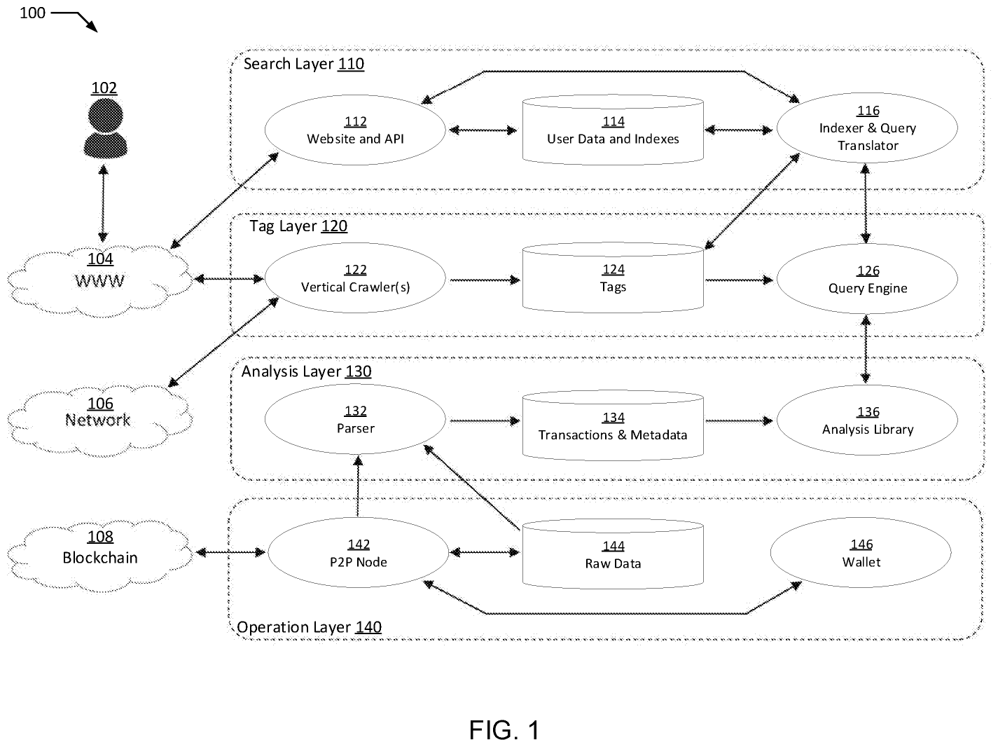

Referring to FIG. 1, a layered blockchain analysis system 100 configured to analyze a blockchain 108 by a user 102 (e.g., analyst, entity, etc.) is illustrated, according to an example embodiment. The layered blockchain analysis system 100 is configured to define a layered architecture that includes an operation layer 140, an analysis layer 130, a tag layer 120, and a search layer 110 (e.g., a query layer). Each of the operation layer 140, analysis layer 130, the tag layer 120, and the search layer 110 are a separate “layer” configured for collecting operational data, analyzing the data, tagging the data, and searching the data, respectively. While each of the operation layer 140, analysis layer 130, the tag layer 120, and the search layer 110 are a “separate” layer, each layer is well-defined and includes extendable interfaces between the interfaces. For example, and expanded upon in greater detail below, the tag layer 120 and the analysis layer 130 may interface through a query engine 126 of the tag layer 120 and an analysis library 136 of the analysis layer 130.

The operation layer 140 (e.g., a first layer) of the layered blockchain analysis system 100 is configured to access and capture the raw data 144 of a blockchain 108. The operation layer 140 is in communication with the blockchain 108 and/or a network with access to the blockchain 108 or distributed ledger. The raw data 144 of a block, some blocks, or all blocks are collected through a peer2peer (P2P) node 142. In some embodiments, the collected raw data is stored in a raw data 144 repository in the layered blockchain analysis system 100 to be subsequently used by a parser 132 of the analysis layer 130. In other embodiments, the raw data 144 is collected and sent directly to a parser 132 of the analysis layer 130. In some embodiments, the P2P node 142 uses a digital wallet 146 to access the blockchain 108 through the P2P node 142. For example, a private/public key pair may be accessed from a wallet 146 to access the blockchain 108 through the P2P node 142 and collect the raw data 142. The raw data 142 may include the transactions, core transaction data, transaction scripts, hashes, annotations, addresses, public keys, cryptographic information, digital signatures, and other information stored in the block of the blockchain 108.

The analysis layer 130 (e.g., a second layer) is configured to parse and analyze the raw data 144 from the blockchain 108. The analysis layer 130 includes a parser 132 to parse out the raw data 144 to define transaction and other meta data 134 from the raw data and store it in an analysis library 136. The analysis layer 130 may implement a programming interface in C++, or a similar programming language, to extend the core analysis library and to define high-level analytical tasks that can be used by a query engine 126 of a tag layer 120. In some embodiments, the blockchain analysis system implemented in the analysis layer 130 incorporates an in-memory, analytical database that is a hundred times faster than conventional blockchain analysis tools. In some embodiments, the analysis layer 130 implements address clustering, also called entity resolution, by grouping of addresses using a method to represent an entity, be it a user, a service, or a customized form of an entity.

The analysis layer 130 of the layered blockchain analysis system 100 is in communication with (e.g., interfaces with, integrate with, etc.) the raw data 144 and/or the P2P node 142 of the operation layer 140. In some embodiments, the parser 132 receives the raw data 144 through the P2P node 142. In some embodiments, the parser 132 retrieves the raw data from a location (e.g., the raw data repository 144) in the operation layer 142. In some embodiments, the parser 132 receives the raw data 144 through both the P2P node 142 and a raw data 144 repository.

In an example, the analysis system also includes a blockchain analysis module. This blockchain module may be configured to analyze the core data of the blockchain data. For example, the blockchain analysis module could include an open-source, scalable blockchain analysis system that use a memory-mapped data structure to represent core transaction data as a graph or a table (e.g., a hash table). This example blockchain analysis module may also include an analytical database, which may use a relational model, a document model, a graph model, or combination of these (or similar) database structure models, and an in-memory storage, an on-desk storage, or a combination of these (or similar) database storage methods. Furthermore, this blockchain analysis module may comprise an analysis library and a data parser.

The analysis layer 130 is configured to interface with (e.g., in communication with, integrate with, etc.) the tag layer 120 through a centralized or distributed, transactional database or a key/value datastore, to integrate annotation and tagging. For example, the analysis library 136 is configured to interface with the tag layer 120 through the query engine 126 of the tag layer 120.

The tag layer 120 (e.g., a third layer) is configured to annotate blockchains with one or more tags and integrate the tags as blockchain objects. The tag layer 120 includes one or more vertical crawlers 122 configured to collect (e.g., scrape) data from a source, a plurality of tags 124 to annotate the data with, and a query engine 126 to interface with the analysis layer 120. In some embodiments, the tag layer 120 implements vertical crawlers to automatically annotate blockchains through customizable tags and define a low-level query interface that integrates tags as first-class blockchain objects.

The vertical crawlers 122 are configured to annotate a blockchain 108 with at least one type of tag in the plurality of tags 124. For example, the vertical crawlers 122 are used to scrape a data source, such as a Tor network 106 or an HTML website or a web-based application programming interface (e.g., REST API) over the Internet 104, in order to automatically create block, transaction, or addresses tags 124 of a particular type using a website-specific parser. In some embodiments, the vertical crawlers 122 can be configured to run according to a crontab-like schedule and to bootstrap on the first run with previously crawled raw HTML/JSON data, which can also be used to initialize blockchain tags. For example, a vertical crawler 122 can be configured to scrape public user account info from a social network or a social media site.

In some embodiments, the tag layer 120 implements four vertical crawlers 122 that are configured to annotate blockchain addresses with three types of tags 124: user tags representing user accounts, service tags representing service providers, and text tags representing user-generated textual labels submitted to a site associate with the blockchain 108. In some embodiments, the vertical crawlers are be configured to scrape auxiliary data of other cryptocurrencies, including Bitcoin®, Litecoin®, Namecoin®, Zcash®, and other distributed ledgers.

The plurality of tags 124 may be a plurality of customizable tags for the blockchain raw data 144 and define a low-level query interface that integrates the customizable tags as objects. For example, a tag 124 may represent a mapping between a block, a transaction, or an address identifier and a list of serializable objects. Each of these objects may specify the type, the source, and any other information that may be considered auxiliary data that describes the tagged identifier. In an example, the tag layer 120 may tag a blockchain address with the user account info of its possible owner. Mapping the information to a list of serializable objects allows for the transmission or storage in a file, as the data are required to be byte strings, but complex objects are seldom in this format. Serialization can convert these complex objects into byte strings for such use. After the byte strings are transmitted, the system can recover the original object from the byte string (e.g., deserialization).

In some embodiments, the plurality of tags 124 of the tag layer 120 may define four types of tags, including user, service, text, and custom tags. A user tag may represent a user account on a social network, whereas a service tag may represent an online service provider such as a cryptocurrency exchange or wallet provider. A text tag may represent a user-customizable text label. For example, a text tag may be a self-described label of an address. A custom tag may represent any type of data. For example, a custom tag may include any of the above listed tags, but may also include other specific tags as determined by a user 102. The indexer and query translator 116 may interface with (e.g., communicate with) the plurality of tags 124 to index the plurality of tags in the tag layer 120.

The query engine 126 is configured to interface with the analysis library 136 of the analysis layer 130 and implement a programming interface that enables users 102 to query transactions by their properties, including tags. In some embodiments, the query engine 126 or another component of the tag layer 120 is configured to allow user 102 to manually annotate blockchains with custom tags at the block, transaction, and address level. In some embodiments, the query engine 126 is configured to link users of social network(s)—captured by the vertical crawlers 122 over the Internet 104—to Tor network services—captured by the vertical crawlers 122 over the Tor network 106—through payments made over the blockchain 108. In some embodiments, the query engine 126 is configured to complete address clustering, which can be configured to operate on a particular source, namely inputs, outputs, or both, using one of the supported clustering methods which group a set of blockchain 108 addresses to represent an owning entity: a user, a service, or a customized form of an entity that owns the private keys of the grouped addresses.

The search layer 110 (e.g., a fourth layer) is configured to search tagged blockchains for useful information in plain English and in real-time and maintain search indexes and user 102 specific data (e.g., authentication tokens, queries, preferences) to provide a personalized, full-stack blockchain analysis. The search layer 110 includes a website and API interface 112 for interfacing with websites and APIs over the Internet 104, an indexer and query translator 116 that is configured to interface with the query engine 126 and/or the plurality of tags 124, and a user data and indexes repository 114.

In some embodiments, the web site and API 112 is a web application or API that is used to authenticate and personalize the user's 102 experience based on user-specific customization that are stored in a separate datastore. The web application may provide the user 102 with an interactive dashboard to search and see an up-to-date report of relevant queries (e.g., security analytics of Bitcoin addresses, showing risk scores, associated users/services, and regulatory compliance issues) over the Internet 104.

The indexer and query translator 116 is configured to index the tags 124 created by the tag layer 120 using a full-text search engine and may include a natural language parser to convert English search queries into tag 124 specific queries. Additionally, the indexer and query translator 116 may be configured for selecting, grouping, and aggregating transactions. For example, a user 102 may initiate a blockchain 108 investigation using a Jupyter notebook that imports the tag layer 120 Python package. The package exposes a chain object representing the blockchain 108. Each block, transaction, and address have a tags object mapping it to some JSON-serializable auxiliary data.

The indexer and query translator 116 may also be configured to determine a blockchain search result based on the blockchain search request. For example, if a user 102 requests a list of user that have participated in transfers with another user, the indexer and query translator 116 may provide the user 102 with a list of users meeting that criteria. Furthermore, the indexer and query translator 116 may provide the user 102 with an interactive dashboard to search and see up-to-date reports based on relevant queries, such as risk scores and associated users/services.

By way of example, a user 102 may use the layered blockchain analysis system 100 to search a collection of blockchain raw data 144 to identify users or services that made any transfers to another specific user. For example, an enforcement authority may want to identify any user who have transferred money or another asset to a criminal organization over a blockchain 108 using a Tor network 106 for communication. The user 102 could leverage the tag layer 120 to have vertical crawlers 122 tag transactions, user information, and service tags, while the query engine 126 interfaces with the analysis library 136 to link the tags 124 with the transactions and metadata 134. In another example, a user 102 may want to verify that a transfer from his own account to another was accurately recorded. In yet another example, an investigator may want to determine a user or service that received an unauthorized transfer from another user account. In order to accomplish such a task, the user may need to make use of an example system for analyzing blockchain of the present disclosure.

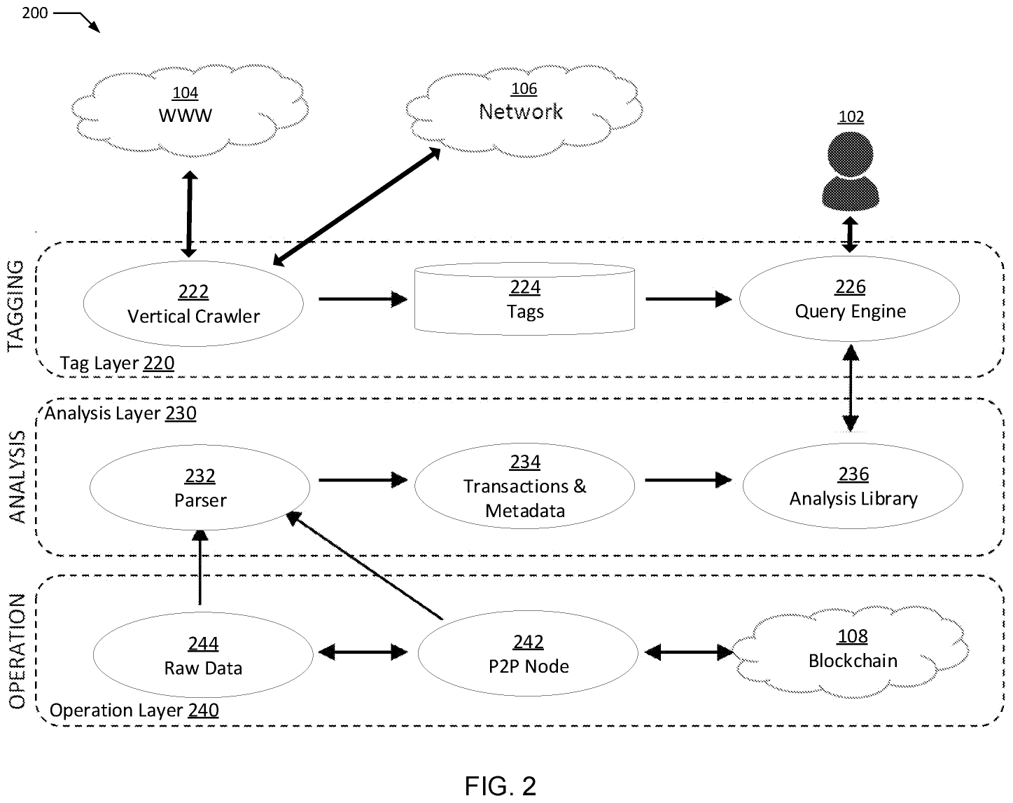

Referring to FIG. 2, a layered blockchain analysis system 200 configured to analyze a blockchain 108 by a user 102 (e.g., analyst, entity, etc.) is illustrated, according to an example embodiment. The layered blockchain analysis system 200 is similar to the layered analysis system 100 of FIG. 1. A difference between the layered blockchain analysis system 200 and the layered blockchain analysis system 100 is the use of a search layer 110 in the layered blockchain analysis system 100 of FIG. 1. Accordingly, like numbering is used to designate like parts between the layered blockchain analysis system 200 and the layered blockchain analysis system 100. For brevity, the description of the layered blockchain analysis system 200 will focus on the tag layer 210. The tag layer 210 of the layered blockchain analysis system 200 allows for the user 102 to identify, customize, map, and/or alter the generation of tags 224 through the query engine 226 of the tag layer 220.

In the tag layer 220, a tag 224 is a mapping between a block, a transaction, or an address identifier and a list of JSON-serializable objects, or similar command or method to encode objects. While JSON is described, other formats that encodes objects into a string may be used in tandem with a means to convert an object into that string (e.g., serialization) and the inverse operation (e.g., deserialization). Each object specifies the type, the source, and other information representing auxiliary data describing the tagged identifier.

As raw blockchain data 244 is stored in a format that is efficient for validating transactions and ensuring immutability, the data must be parsed and transformed it into a simple data structure that is efficient for analysis. For example, the analysis layer 230 may use a memory-mapped data structure to represent core transaction data as a graph. All other transaction data, such as hashes and scripts, are stored separately as mappings that are loaded when needed. In some embodiments, the tag layer 220 uses a persistent key-value database with an in-memory cache in order to store and manage blockchain tags, as they can grow arbitrarily large in size.

In some embodiments, the tag layer 220 defines four types of tags: user, service, text, and custom tags. A user tag represents a user account on an online social network, such as BitcoinTalk and Twitter. A service tag represents an online service provider, such as Tor hidden services like Silk Road and The Pirate Bay. A text tag represents a user-generated textual label, such as address labels submitted to Blockchain.info. A custom tag can hold arbitrary data, including other tags, and is usually used when creating tags manually by analysts.

In the tag layer 220, tags are created, updated, and removed at the block, transaction, or the address level. A direct, read-only access to tags 224 is possible at any level through the tags object of a block, a transaction, and an address. By default, in some embodiments, the tag layer 220 is configured to return the tag of an identifier at a given level along with the tags of identifiers from lower levels. Accordingly, the tag layer 220, by way of the layered architecture of the layered blockchain analysis system 200, is sufficient to tag 224 only addresses in order to annotate the whole blockchain 108.

For example, the tag layer 220 may be used by the user 102 to define tags 224 to map Bitcoin's genesis address to Satoshi's—the creater of Bitcoin—BitcoinTalk user account. An append flag may be used to indicate whether the value defined in this tag should be appended to the existing list, as the address can have other tag values defined already. An example code for tags 224 could be defined by a user 102 as:

import blocktag
chain = blocktag.Blockchain(‘/path/to/blockchain/data/’)
chain.tag(

level=‘address’,
key=‘1A1zP1eP5QGefi2DMPTfTL5SLmv7DivfNa’,
value=[{

‘type’: ‘user’,
‘source’: ‘bitcointalk’,
‘info’: {

‘id’: 3,
‘account’: ‘satoshi’,
‘num_posts’: 575,
‘num_activities’: 364,
‘position’: ‘founder’,
‘date_registered’: ‘2009-11-19 19:12:39’,
‘last_seen’: ‘2010-12-13 16:45:41’

}

}],
append=False

)

The vertical crawler 222 is used to scrape a data source, typically an HTML website or a web-based API, over a network 106 and/or the Internet 104. The vertical crawler 222 is configured to automatically create block, transaction, or addresses tags of a particular type using a website-specific parser. In some embodiments, the vertical crawler 222 is configured to run according to a crontab-like schedule and to bootstrap on the first run with previously crawled raw HTML/JSON data, which can also be used to initialize blockchain tags 224. An example code for configuring the vertical crawler 222 could be defined by a user 102 to run a user crawler at the address level every day at midnight on a social media website (i.e., “Social Media”):

chain.crawl(

level=‘address’,
config={

‘type’: ‘user’,
‘source’: ‘Social Media’,
‘schedule’: ‘0 0 * * *’,
‘data’: ‘/path/to/socialmedia/data/’

}

)

In the above code, and by way of example, the, chain.crawl( ) generates a vertical crawler 222 that downloads user account pages through a URL over the Internet 104 that is unique for each user account. The HTML pages are then parsed to find cryptocurrency addresses using regular expressions. For example, as with Bitcoin, if the cryptocurrency address is a base58 encoded identifier of 26-35 alphanumeric characters, beginning with the number 1 or 3, in which case the crawler uses the regex *[13][a-km-zA-HJ-NP-Z1-9]25,34 and eventually creates or updates a user tag for the matched address. In some embodiments, the vertical crawler 222 is configured to parse and collect data over social media APIs, a Tor hidden service crawler that scrapes landing pages of indexed service providers, and/or a text crawler that scrapes textual labels that are self-signed by address owners or submitted by arbitrary users.

The query engine 226 is configured to provide the user 102 with the ability to select, group, and aggregate transactions through a query interface. In some embodiments, a visualization is implemented to show an operational dashboard of different components of the layered blockchain analysis system 200. To write a query, the user 102 may specify block, transaction, or address properties to which the results should match using the where parameter. The tag layer 220, by way of the query engine 226, treats each property as having an implicit boolean AND. In some embodiments, the tag layer 220 natively supports boolean OR queries, but the user 102 could use a special $or operator to achieve boolean OR queries. In addition to exact matches, the query engine 226 has operators for string matching, numerical comparisons, etc. The user 102 can also specify the properties by which the results are grouped using a group_by parameter feature. The user 102 can also specify which properties to return per result with the select parameter.

The query engine 226 may implement address clustering, which is configured to operate on a particular source, namely inputs, outputs, or both, using one of the supported clustering methods, all through the clustering parameter. Address clustering expands the set of addresses that are mapped to a unique user, service, or text tag through a technique called closure analysis. As a result, this allows the user 102 to identify more links between different tags by considering a larger number of transactions in the blockchain 108.

Additionally, the query engine 226 and/or the tag layer 220 may support multiple address clustering methods. A first method is through an original closure heuristic which works as follows: If a transaction has addresses A and B as inputs, then A and B belong to the same cluster. A second method may be implemented that uses a minimal clustering method that prematurely terminates the original clustering method before the clusters grow to their maximum size. Minimal clustering includes a final trimming phase to find clusters that share at least one address and consequently merges them, after which they are removed. Doing so ensures that the clusters are mutually-exclusive and likely to belong to separate entities, but also means the clusters are smaller than usual, reducing the chance of linking different tags 224 as a result.

An example code for configuring the query engine 226 could be defined by a user 102 to find social media user accounts (i.e., Social Media) who paid≥B10.0 to the Silk Road Tor hidden service in the year 2014 as:

accounts = chain.query(

```
  level=‘transaction’,
  select= ‘input.address.tag.info.account’,
  where={
```

‘input’: {

‘address’:

‘tag’: {
‘type’: ‘user’,
‘source’: ‘Social Media’

}

}

},
‘output’: {
‘address’: {

```
  ‘tag’: {
  ‘type’: ‘service’,
    ‘source’: ‘tor’,
    ‘info’: {
```

‘provider’: {‘$like’: ‘silkroad’ }

```
  }
  }
```

}
},

‘time’: ‘2014’
},
group_by=‘input.address.tag.info.id’,
having=‘sum(input.value) >= (10.0 * 10**7)’,
clustering={ ‘source’: ‘inputs’, ‘method’: ‘original’ }

)

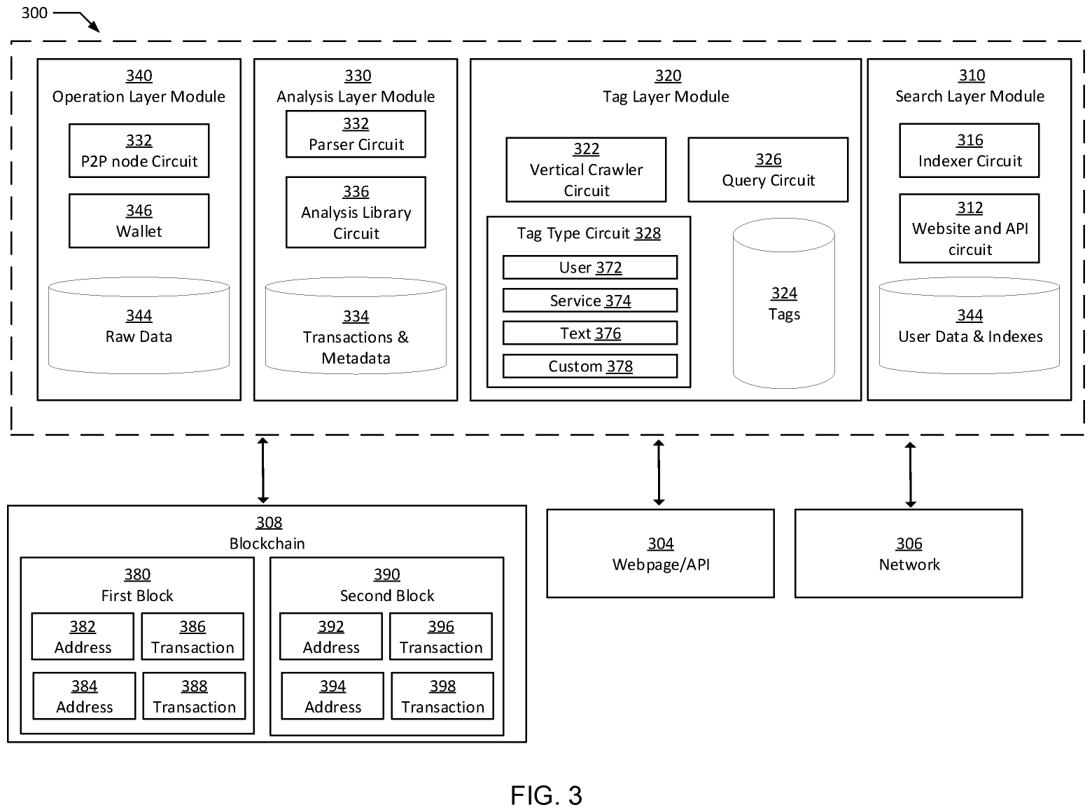

FIG. 3 illustrates a block diagram of a layered blockchain analysis system 300, according to an example of the present disclosure. The layered blockchain analysis system 300 is similar to the layered analysis system 100 of FIG. 1. Accordingly, like numbering is used to designate like parts between the layered blockchain analysis system 300 and the layered blockchain analysis system 100. The layered blockchain analysis system 300 is configured to annotate tags that map blocks, transactions, and addresses to user accounts, service providers, text labels, and other types of tags. The layered blockchain analysis system 300 allows a user to link tags to each other by findings blockchain transactions involving tag identifiers.

The layered blockchain analysis system 300 includes an operation layer module 340, an analysis layer module 330, a tag layer module 320, and a search layer module 310. The layered blockchain analysis system 300 is configured to communicate with and collect data from a blockchain 308, webpage(s) and API(s) 304, and various networks 306 (e.g., Tor network). The tag values represent auxiliary data that is collected from public sources, which include, for example, social networks 304, Tor hidden services 306, and blockchains 308. The blockchain 308 includes a plurality of blocks, including a first block 380 and a second block 390. The first block 380 includes a plurality of addresses 382, 384 associated with a plurality of transaction 386, 388 over the blockchain 308. The second block 390 includes a plurality of addresses 392, 394 associated with a plurality of transaction 396, 398 over the blockchain 308.

The operation layer module 340 is configured to access and capture the raw data in the blocks 380, 390 of the blockchain 308. The raw data (e.g., addresses 382, 384 and transaction 386, 388) of the first block 380 and the raw data (e.g., addresses 392, 39 and transaction 396, 398) of the second block 380 are collected through a P2P node circuit 332. In some embodiments, the collected raw data is stored in a raw data repository 344 to be subsequently used by a parser circuit 332 of the analysis layer module 330. In other embodiments, the raw data is collected and sent directly to the parser circuit 332. In some embodiments, the P2P node circuit 142 uses a digital wallet 346 to access the blockchain 308. The raw data 344 captured may include the transactions, core transaction data, transaction scripts, hashes, annotations, addresses, public keys, cryptographic information, digital signatures, and other information stored in the block of the blockchain 308.

The analysis layer module 330 is configured to parse and analyze the raw data 344 from the blockchain 308. The analysis layer module 330 includes a parser circuit 332 to parse out the raw data 344 to define and/or store transaction and other meta data in a database 334 and analyze the stored/define data using an analysis library circuit 336. The analysis layer module 330 may implement a programming interface in C++—or a similar programming language—to extend the core analysis library and define high-level analytical tasks. In some embodiments, the blockchain analysis system implemented in the analysis layer module 330 incorporates a memory-mapped, key/value datastore with analytical capabilities that are a hundred times faster than conventional blockchain analysis tools. In other embodiments, the blockchain analysis system implemented in the analysis layer module 330 incorporates a transactional database which uses a relational model, a document model, a graph model, or combination of these (or similar) database structure models, and an in-memory storage methods.

The analysis layer module 330 of the layered blockchain analysis system 300 is in communication with (e.g., interfaces with, integrate with, etc.) the raw data repository 344 and/or the P2P node circuit 342 of the operation layer module 340. In some embodiments, the parser circuit 332 receives the raw data 344 through the P2P node circuit 342. In some embodiments, the parser 332 receives the raw data 344 through both the P2P node 342 and a raw data repository 344. The analysis layer module 330 is configured to interface with (e.g., in communication with, integrate with, etc.) the tag layer module 320 through a centralized, transactional database to integrate annotation and tagging. For example, the analysis library circuit 336 may be configured to interface with the tag layer module 320 through the query engine circuit 326 of the tag layer module 320.

The tag layer module 320 is configured to annotate blockchains with one or more tags and integrate the tags as blockchain objects. The tag layer module 320 includes one or more vertical crawler circuit 322 configured to collect (e.g., scrape) data from a source, an index of tags 324 to annotate the data with, a tag type circuit 328, and a query engine circuit 326 to interface with the analysis layer module 320. In some embodiments, the tag layer module 320 is configured to determine a plurality of customizable tags for the blockchain data and define a low-level query interface that integrates the customizable tags as objects. For example, a tag may represent a mapping between a block, a transaction, or an address identifier and a list of serializable objects. Each of these objects may specify the type, the source, and any other information that may be considered auxiliary data that describes the tagged identifier. In an example, the tag layer module 320 may tag a blockchain address with the user account info of its possible owner.

The vertical crawler circuit 322 is configured to generate one or more vertical crawlers to collect (e.g., scrape) a data source, for example, the webpage/API 304 or the network 306, to create and assign these types of tags. For example, the vertical crawler circuit 322 may use a vertical crawler on an HTML website or a web-based API to create a series tags corresponding to blocks, transactions, users, and addresses. The vertical crawler circuit 322 are configured to annotate blockchain 308 addresses with at least one type of tag in the plurality of tags 324 and/or tag types.

The tag type circuit 328 is configured to define four types of tags, including user 372, service 374, text 376, and custom tags 378. A user tag 372 may represent a user account on a social network. A service tag 374 may represent an online service provider such as a cryptocurrency exchange or wallet provider. A text tag 376 may represent a user-customizable text label. For example, a text tag 376 may be a self-described label of an address. A custom tag 378 may represent any type of data. For example, a custom tag 378 may include any of the above listed tags, but may also include other specific tags as determined by a user.

The query circuit 326 is configured to interface with the analysis library circuit 336 of the analysis layer module 330 and implement a programming interface that enables users to query transactions by their properties, including tags. In some embodiments, the query circuit 326 or another component of the tag layer module 320 is configured to allow user to manually annotate blockchains with custom tags at the block, transaction, and address level. In some embodiments, the query circuit 326 is configured to link users of social network(s)—captured by the vertical crawlers over the internet—to Tor network services—captured by the vertical crawlers over the network 306—through payments made over the blockchain 308. In some embodiments, the query circuit 326 is configured to complete address clustering, which can be configured to operate on a particular source, namely inputs, outputs, or both, using one of the supported clustering methods.

The search layer module 310 is configured to search tagged blockchains for useful information in plain English and in real-time and maintain search indexes and user specific data (e.g., authentication tokens, queries, preferences) to provide a personalized, full-stack blockchain analysis. The search layer module 310 includes a website and API interface circuit 312 for interfacing with websites and APIs 304, an indexer circuit 316 that is configured to interface with the query circuit 326 and/or the plurality of tags 324, and a user data and indexes repository 334. The indexer circuit 316 may interface with (e.g., communicate with) the plurality of tags 324 to index the plurality of tags in the tag layer module 320.

The search layer module 310 may be configured to receive a blockchain search request. In an example, a user may wish to determine any number of users that transferred funds to a criminal organization. The search layer module 310 may also receive and interpret plain English search requests. For example, the search layer module 310 may make use of a natural language parser to convert a plain English search request into a query that allows searching of tagged objects. In the example, the user may provide a request to the search layer module 310 that states, “which users transferred funds to Example Organization,” which the blockchain search module may convert into a query to be understood as requesting users related to tags corresponding to the Example Organization.

The search layer module 310 may be further configured to maintain a plurality of search indexes and a plurality of user specific data. For example, the search layer module 330 may maintain the user specific data so as to provide a personalized, blockchain analysis experience by providing search results based on previous queries and user preferences. Furthermore, the search layer module 310 may index the tags created by the blockchain tag module by using a full-text search engine.

In some embodiments, the web site and API 312 circuit is a web application or a web-based API that is used to authenticate and personalize the user's 302 experience based on user-specific customization that are stored in a separate datastore. The web application may provide the user 302 with an interactive dashboard to search and see an up-to-date report of relevant queries (e.g., security analytics of Bitcoin addresses, showing risk scores, associated users/services, regulatory compliance issues) over the internet 304.

The indexer circuit 316 is configured to index the tags 324 created by the tag layer module 320 using a full-text search engine and may include a natural language parser to convert English search queries into tag 324 specific queries. Additionally, the indexer and query translator 316 may be configured for selecting, grouping, and aggregating transactions. For example, a user 302 may initiate a blockchain 308 investigation using a Jupyter notebook that imports the tag layer module 320 Python package. The package exposes a chain object representing the blockchain 308. Each block, transaction, and address have a tags object mapping it to some JSON-serializable auxiliary data.

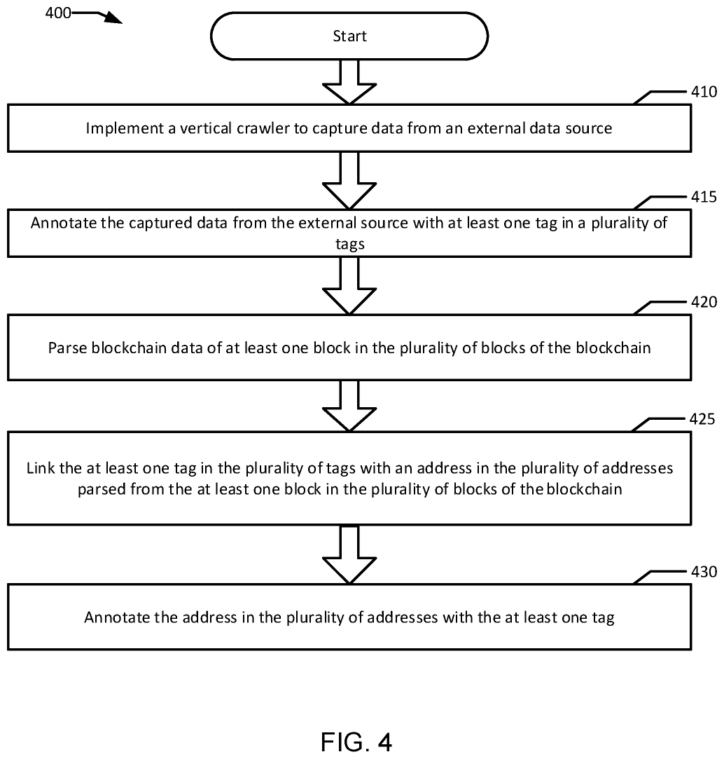

FIG. 4 illustrates a flowchart illustrating an example method 400 for analyzing and layering a blockchain according to an example embodiment of the present disclosure. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, blocks may be repeated, and some of the blocks described are optional. The method 400 may be performed by processing logic that may comprise hardware (circuitry, dedicated logic, etc.), software, or a combination of both.

The example method 400 includes implementing a vertical crawler to capture data from an external source (block 410). The data source may be an HTML website or an API, over a network and/or the internet. The vertical crawler may be configured to automatically create block, transaction, or addresses tags of a particular type using a website-specific parser. In some embodiments, the vertical crawler is configured to run according to a crontab-like schedule and to bootstrap on the first run with previously crawled raw HTML/JSON data, which can also be used to initialize blockchain tags.

The method 400 also includes annotating the captured data from the external source with at least one tag in the plurality of tags (block 415). The tag may be one of four types of tags: user, service, text, and custom tags. For example, a vertical crawler may download user account pages through a URL over the Internet 104 that is unique for each user account. The HTML pages are then parsed to find cryptocurrency addresses using regular expressions.

The method 400 also includes parsing blockchain data of at least one block in the plurality of blocks of the blockchain (block 420). The parsing may include parsing and analyzing raw transaction data for a distributed ledger or blockchain. The data may be further processed to be in a searchable and annotatable format. In other words, the raw blockchain data is stored in a format that is efficient for validating transactions and ensuring immutability, the data must be parsed and transformed it into a simple data structure that is efficient for analysis.

The method 400 also includes linking the at least one tag in the plurality of tags with an address in the plurality of addresses parsed from the at least one block in the plurality of blocks of the blockchain (block 425). The method 400 also includes annotating the address in the plurality of addresses with the at least one tag (block 430). Annotating the addresses allows for a user or analyst to select, group, and aggregate transactions through a query interface. In some embodiments, a visualization is implemented to show an operational dashboard of different components of the layered blockchain analysis system. To write a query, the user may specify block, transaction, or address properties to which the results should match using the where parameter. In some embodiments, the annotation is configured such that a query will return returns the tag of an identifier at a given level along with the tags of identifiers from lower levels. This means it is sufficient to tag only addresses in order to annotate the whole blockchain.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

The invention is claimed as follows:

1. A system, comprising:
a blockchain comprising a plurality of blocks, each block comprising a plurality of transactions and a plurality of addresses, each transaction associated with at least one address in the plurality of addresses; and
a server system in operative communication with the blockchain system, the server system comprising a processor and instructions stored in non-transitory machine-readable media, the instructions configured to cause the server system to:
implement a vertical crawler to capture data from an external data source, the external data source different from the blockchain;
annotate the captured data from the external source with at least one tag in a plurality of tags;
parse blockchain data of at least one block in the plurality of blocks of the blockchain;
link the at least one tag in the plurality of tags with an address in the plurality of addresses parsed from the at least one block in the plurality of blocks of the blockchain; and
annotate the address in the plurality of addresses with the at least one tag.

2. The system of claim 1, wherein the instructions are further configured to cause the server system to query the plurality of addresses in the at least one block for a property of an address in the plurality of addresses, the property associated with the at least one tag.

3. The system of claim 2, wherein the instructions are further configured to cause the server system to return each address in the plurality of addresses that are annotated with the at least on tag associated with the property queried.

4. The system of claim 1, wherein the at least one tag is a first tag in the plurality of tags, and wherein the instructions are further configured to cause the server system to link a second tag in the plurality of tags with a transaction in the plurality of transactions parsed from the at least one block in the plurality of blocks of the blockchain; and annotate the transaction in the plurality of transactions with the second tag.

5. The system of claim 4, wherein the instructions are further configured to cause the server system to query the plurality of addresses in the at least one block for a property of the addresses in the plurality of addresses, the property associated with at least one of the first tag and the second tag.

6. The system of claim 5, wherein the instructions are further configured to cause the server system to return each address in the plurality of addresses that are annotated with at least one of the first tag and the second tag associated with the property.

7. The system of claim 4, wherein the instructions are further configured to cause the server system to query the plurality of transactions in the at least one block for a property of a transaction in the plurality of addresses, the property associated with at least one of the first tag and the second tag.

8. The system of claim 7, wherein the instructions are further configured to cause the server system to return each transaction in the plurality of transactions that are annotated with at least one of the first tag and the second tag associated with the property.

9. The system of claim 1, wherein the plurality of tags comprises a user tag, a service tag, and a text tag, the user tag associated with a user account, the service tag associated with a service provider, and the text tag associated with a textual label.

10. A method for analyzing blockchain, the method comprising
implementing, by a computing system, at least one vertical crawler to capture data from an external data source, the external source different from a blockchain, the blockchain comprising a plurality of blocks, each block comprising a plurality of transactions and a plurality of addresses, each transaction associated with at least one address in the plurality of addresses;
annotating, by the computing system, the captured data from the external source with at least one tag in a plurality of tags;
parsing, by the computing system, blockchain data of at least one block in the plurality of blocks of the blockchain;
linking, by the computing system, the at least one tag in the plurality of tags with an address in the plurality of addresses parsed from the at least one block in the plurality of blocks of the blockchain; and
annotating, by the computing system, the address in the plurality of addresses with the at least one tag.

11. The method of claim 10, further comprising querying, by the computing system, the plurality of addresses in the at least one block for a property of an address in the plurality of addresses, the property associated with the at least one tag, and returning, by the computing system, each address in the plurality of addresses that are annotated with the at least on tag associated with the property queried.

12. The method of claim 10, wherein the at least one tag is a first tag in the plurality of tags, and further comprising, linking, by the computing system, a second tag in the plurality of tags with a transaction in the plurality of transactions parsed from the at least one block in the plurality of blocks of the blockchain; and annotating, by the computing system, the transaction in the plurality of transactions with the second tag.

13. The method of claim 12, further comprising querying, by the computing system, the plurality of addresses in the at least one block for a property of the addresses in the plurality of addresses, the property associated with at least one of the first tag and the second tag, and returning, by the computing system, each address in the plurality of addresses that are annotated with at least one of the first tag and the second tag associated with the property.

14. The method of claim 12, further comprising, querying, by the computing system, the plurality of transactions in the at least one block for a property of a transaction in the plurality of addresses, the property associated with at least one of the first tag and the second tag, and returning, by the computing system each transaction in the plurality of transactions that are annotated with at least one of the first tag and the second tag associated with the property.

15. The method of claim 10, wherein the plurality of tags comprises a user tag, a service tag, and a text tag, the user tag associated with a user account, the service tag associated with a service provider, and the text tag associated with a textual label.

16. A system for analyzing blockchain comprising:
a blockchain data source configured to contain a plurality of blockchain data;
a blockchain analysis module configured to analyze core data of the blockchain data, the core data;
a blockchain tag module configured to:
determine a plurality of customizable tags based on the blockchain data; and
define a low-level query interface that integrates customizable tags as objects based on the customizable tags;
a blockchain search module configured to:
receive a blockchain search request;
maintain a plurality of search indexes and a plurality of user-specific data; and
determine a blockchain search result based on the blockchain search request.

17. The system of claim 16, wherein the blockchain tag module is configured to annotate the core data with the plurality of customizable tags.

18. The system of claim 16, wherein the blockchain data is associated with a blockchain comprising a plurality of blocks, each block comprising a plurality of transactions and a plurality of addresses, each transaction associated with at least one address in the plurality of addresses, and wherein the determining the plurality of customizable tags comprises implementing a vertical crawler to capture data from an external data source, the external data source different from the blockchain.

19. The system of claim 18, wherein the plurality of search indexes are generated by parsing the blockchain data of at least one block in the plurality of blocks of the blockchain, linking the at least one tag in the plurality of tags with an address in the plurality of addresses parsed from the at least one block in the plurality of blocks of the blockchain; and annotating the address in the plurality of addresses with the at least one tag

20. The system of claim 18, wherein determining a blockchain search result based on the blockchain search request comprises querying the plurality of addresses in the at least one block for a property of the addresses in the plurality of addresses, the property associated with at least tag in the plurality of customizable tags.
